(19) United States
(12) Patent Application Publication
(10) Pub. No.: US 2008/0224814 A1
(43) Pub. Date: Sep. 18, 2008

(54) ELECTRICAL ASSEMBLY AND MANUFACTURING METHOD

(75) Inventors: Slobadan Pavlovic, Canton, MI (US); Mohamad Zeidan, Dearborn Heights, MI (US); Dave Menzies, Sterling Heights, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/685,379

(22) Filed: Mar. 13, 2007

(51) Int. Cl. H01H 85/04

(52) U.S. Cl. 337/164

(57) ABSTRACT

The disclosed embodiments include a method of manufacturing and electrical assembly. The method includes forming a first electrical component at a first stamping machine. The method also includes forming a second electrical component at a second stamping machine. The method further includes forming a third electrical component at a third stamping machine and receiving the first, second and third electrical components at an assembly machine. The first, second and third electrical components are then assembled into a unitary electrical assembly.

### TECHNICAL FIELD

The embodiments described herein relate to an electrical assembly and method of manufacturing the electrical assembly.

### BACKGROUND

In an effort to streamline manufacturing processes, many manufacturing systems utilize a single manufacturing tool to form or fabricate electrical assemblies. For example, electrical assemblies such as fuse arrays that may be used on vehicles are conventionally manufactured by a single manufacturing tool or machine. These manufacturing tools are designed to manufacture fuse arrays having specific sizes and dimensions. However, it is well known that from vehicle to vehicle the design of the fuse array may vary. To accommodate the need for fuse arrays of varying sizes and dimensions, the conventional manufacturing systems require the redesign of the manufacturing tool or the purchase of a new tool. Thus, conventional fuse array manufacturing systems are inept at efficient manufacturing of fuse arrays having varying sizes and dimensions.

The embodiments described herein were conceived in view of these and other disadvantages of conventional manufacturing systems for electrical assemblies.

### SUMMARY

The disclosed embodiments include a novel electrical assembly (e.g., a fuse array) and method for manufacturing the electrical assembly. The method includes forming a first electrical component at a first stamping machine. The method also includes forming a second electrical component at a second stamping machine. The method further includes forming a third electrical component at a third stamping machine and receiving the first, second and third electrical components at an assembly machine. The method also includes assembling the first, second and third electrical components into a unitary electrical assembly.

The manufacturing system includes a first stamping machine for forming a first electrical component. A second stamping machine is included that forms a second electrical component. A third stamping machine forms a third electrical component. In one embodiment, an assembly machine receives the first, second and third electrical components wherein the assembly machine assembles the first, second and third electrical components into a unitary electrical assembly.

Additionally, the embodiments described herein include the novel electrical assembly. In one aspect of the invention, the electrical assembly includes a fuse array. The fuse array has a bus bar having a bus bar weld interface. A fuse element is included that has a first fuse element weld interface and a second fuse element weld interface. A terminal blade has a terminal blade weld interface. In one embodiment, the bus bar is connected to the fuse element by welding the bus bar weld interface to the first fuse element weld interface. Furthermore, the fuse element is connected to the terminal blade by welding the second fuse element weld interface to the terminal blade weld interface.

### BRIEF DESCRIPTION OF THE DRAWINGS

The novel features of the described embodiments are set forth with particularity in the appended claims. These embodiments, both as to their organization and manner of operation, together with further advantages thereof, may be best understood with reference to the following description, taken in connection with the accompanying drawings in which:

FIG. 1 illustrates a manufacturing system in accordance with one embodiment of the present invention;

FIGS. 2A and 2B illustrate alternative fuse arrays that may be manufactured by the manufacturing system of FIG. 1; and

FIG. 3 illustrates a flow chart of a method of manufacturing an electrical assembly in accordance with an embodiment of the present invention.

### DETAILED DESCRIPTION OF THE EMBODIMENT(S)

As required, detailed descriptions of embodiments are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific functional details disclosed herein are not to be interpreted as limiting, but merely as a representative basis for the claims and/or as a representative basis for teaching one skilled in the art.

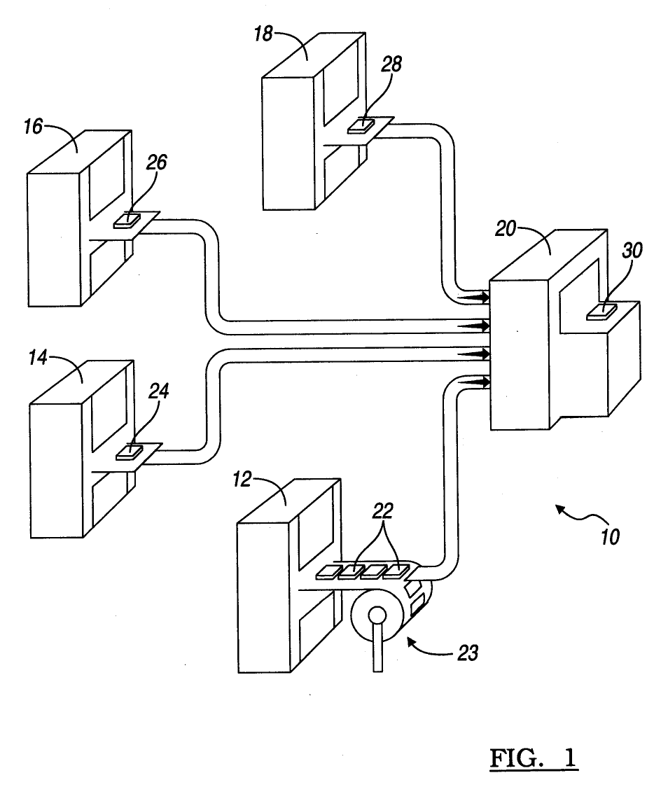

Referring to FIG. 1, a manufacturing system 10 is illustrated that enables efficient and cost-effective manufacturing of electrical assemblies. In one embodiment, manufacturing system 10 is configured to manufacture electrical assemblies such as fuse arrays. Manufacturing system 10 includes a plurality of stamping machines and an assembly machine for forming and assembling the electrical assemblies. The machines are each responsible for manufacturing a component of the electrical assembly. Each machine is configured to receive a blank that is then formed (e.g., stamped, coined and the like) into the desired component of the electrical assembly. Accordingly, electrical assemblies having varying sizes and dimensions may be efficiently made simply by programming each machine to form its respective component in accordance with the desired fuse array size and dimensions.

As shown, manufacturing system 10 includes a stamping machine 12, a stamping machine 14, a stamping machine 16, and a stamping machine 18. An assembly machine 20 may also be included for final assembly of the electrical assembly (e.g., fuse arrays). In some embodiments, a molding machine may be included for molding plastic parts that are attached to the fuse arrays. Although, assembly machine 20 is illustrated, it is recognized that assembly of the fuse array may occur manually thereby eliminating the need for a dedicated assembly machine such as assembly machine 20. Machines 12, 14, 16, 18, and 20 may be individual work cell tools available from Automotive Tooling Systems Inc., having the address of Preston Centere, 250 Royal Oak Road, Box 32100, Cambridge, Ontario N3H 5M2. In one embodiment, the machines illustrated in manufacturing system 10 may be work cells that are available from the ATS Flexsys™ family of automated manufacturing tools. Machines 12, 14, 16, 18, and 20 may be located at a single manufacturing facility or distributed across multiple manufacturing facilities.

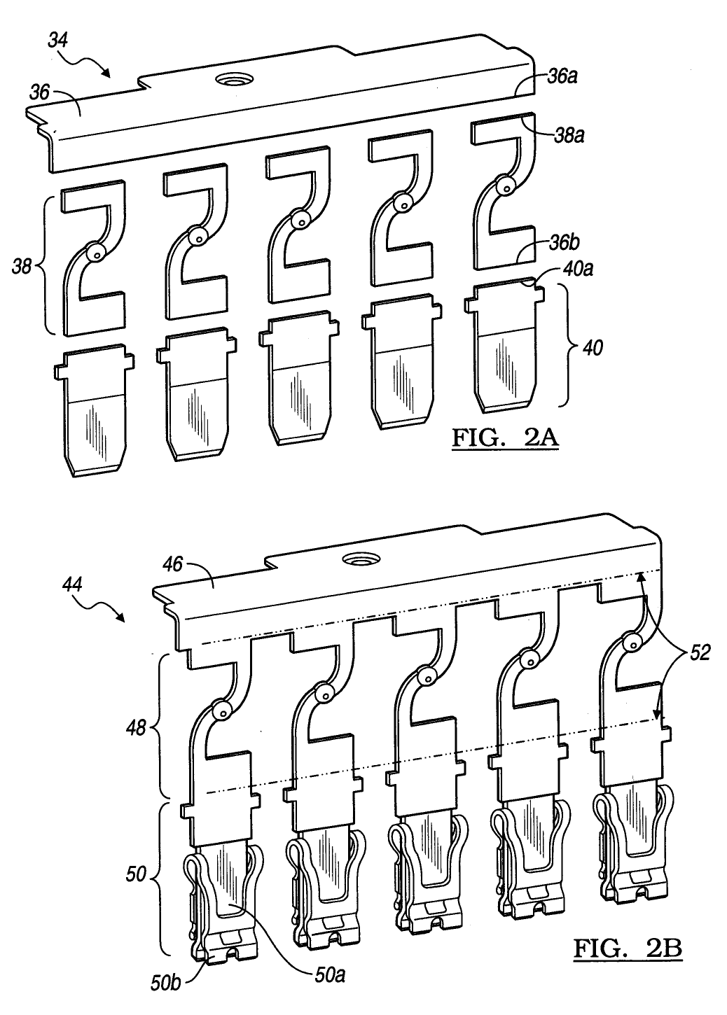

As stated above, the electrical assembly manufactured via manufacturing system 10 may be a fuse array that is commonly used on vehicles. FIGS. 2A and 2B illustrate alternative embodiments of fuse arrays 34 and 44, that may be manufactured by manufactured system 10.

Specifically referring to FIG. 2A, fuse array 34 is shown in an exploded view. Fuse array 34 includes a bus bar 36, a fuse element 38, and an electrical terminal blade 40. Bus bar 36 includes a bus bar weld interface 36a. Fuse element 38 includes fuse element weld interfaces 38a and 38b. Additionally, terminal blade 40 includes a terminal blade weld interface 40a.

Fuse array 34 may be assembled into a unitary device by welding bus bar 36, fuse element 38 and terminal blade 40 at the weld interfaces. Particularly, bus bar 36 would be welded to fuse element 38 at weld interfaces 36a and 38a. Fuse element 38 may be connected to terminal blade 40 at weld interfaces 38b and 40a.

FIG. 2B illustrates an embodiment of the fuse array having female terminals. Fuse array 44 includes a bus bar 46, a fuser element 48 and a female terminal 50. Female terminal 50 further includes a blade 50a and a spring 50b that is fixedly attached to blade 58. Spring 50b may also have a weld interface that enables it to be connected (e.g., welded) to blade 50a. Bus bar 46, fuse element 48, and female terminal 50 may be assembled as a unitary device by welding each component together at weld interfaces 52.

Now, referring back to FIG. 1, stamping machine 12 may be configured to manufacture a fuse element 22. As shown, the manufactured fuse element may be placed on a reel 23 when formed by stamping machine 12. Although reel 23 is shown in connection with machine 12, machines 14, 16, and 18 may also have reels connected thereto. It is recognized that stamping machine 12 may be adapted to cut a metal die as well as coin material in an efficient manner. Once fuse element 22 is formed, it is then provided to assembly machine 20. Stamping machine 14 may be specifically programmed to form a terminal blade 24. Additionally, stamping machine 16 may be configured to form a bus bar 26 while stamping machine 18 forms a spring 28 to enable the assembly of a fuse array having a female terminal. Upon the formation of fuse element 22, terminal blade 24, bus bar 26, and spring 28, assembly machine 20 is adapted to receive the various components and assemble the components into a unitary device (i.e., fuse array). Assembling of the fuse array may occur through ultrasonic welding, laser welding, resistance welding, and the like. As described in the foregoing, it is recognized that final assembly of the electrical assembly may occur manually thereby eliminating the need for assembly machine 20.

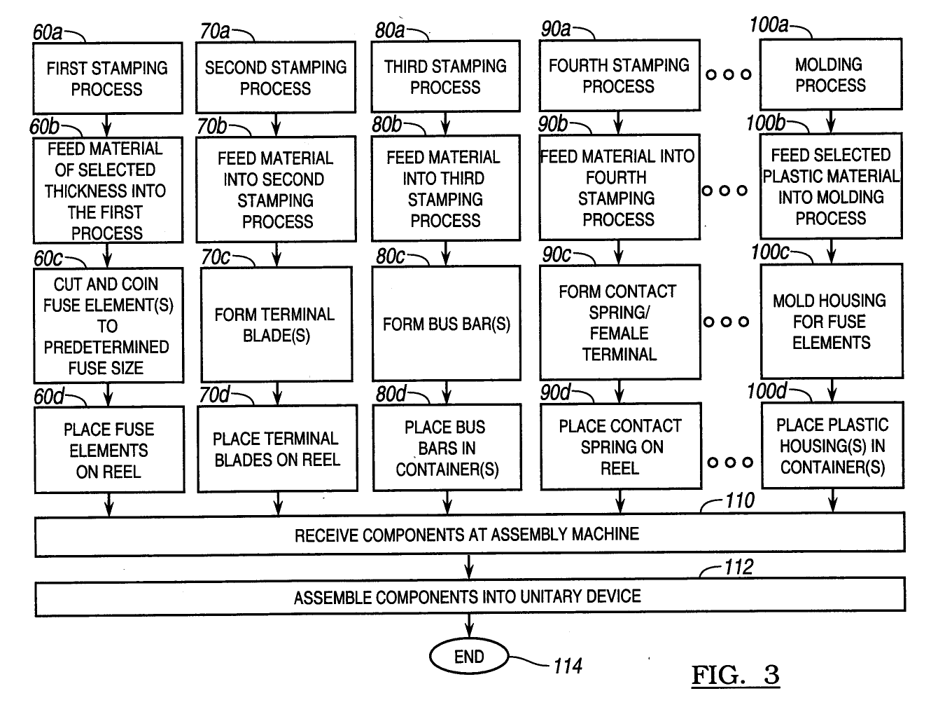

Now, referring to FIG. 3, a flow chart for manufacturing a fuse array is provided. The method includes a first stamping process 60 (60a-60d), a second stamping process 70 (70a-70d), a third stamping process 80 (80a-80d), a fourth stamping process 90 (90a-90d), and a molding process 100 (100a-100d). It is recognized that other stamping processes may be included in alternative embodiments without departing from the scope of the present invention. Process 60, 70, 80, 90 and 100 may occur simultaneously or at different times in accordance with scheduling requirements.

As shown, first stamping process 60a may be a process for forming the fuse elements. Process 60a includes the step of feeding material of a selected thickness into the first process at 60b. Accordingly, 60b includes the receipt of a predetermined material having a desired thickness. In one embodiment, the selected thickness for the material may be 0.8 mm. At block 60c, the material is cut (i.e., stamped) and coined to form a fuse element having a predetermined fuse size. In one embodiment, the fuse element is coined to have a thickness in the range of 0.3 mm to 0.4 mm. It is recognized that alternative embodiments may have different thicknesses in accordance with design and performance requirements. At block 60d, the fuse element may be placed on a reel. Accordingly, the fuse element is received at an assembly machine as shown at block 110.

Stamping process 70 illustrates a process for forming the terminal blades. At block 70a, the second stamping process is initiated. Block 70b illustrates the receipt of material into the second stamping process (i.e., the stamping machine). At block 70c, the stamping machine forms the terminal blades. In one embodiment, the terminal blades may have a thickness of 0.8 mm and a width between 6.3 mm and 9.5 mm. The width of the terminal blades may differ depending upon the particular performance requirement of the fuse array. At block 70d, the terminal blades are placed on a reel. As such, the terminal blades are supplied to the assembly machine as shown in block 110.

Process 80 illustrates a process for forming the bus bars. At block 80a the process 80 is initiated. The next step includes feeding material into a third stamping process or machine (80b). Accordingly, a bus bar is formed via a stamping process at 80c. Block 80d depicts placement of the bus bar in to containers. Subsequently, the bus bars are received at assembly machine as depicted by block 110.

Process 90 depicts a process for forming an electrical spring for fuse arrays configured for female terminals. The fourth stamping process begins at block 90a. Accordingly, material is fed into a fourth stamping process (i.e., the stamping machine) as depicted by block 90b. As shown by block 90c, a contact spring is formed by the stamping machine. Block 90d illustrates placement of the contact spring on a reel. At block 110, the contact spring is received at an assembly machine.

Process 100 illustrates a process for molding plastic components that are attached to the fuse array. The molding process begins at block 100a. As depicted by block 100b, a selected plastic material is fed into the molding process. Block 100c illustrates molding of a housing for the fuse element. Block 100d illustrates placement of the plastic housings and containers. Accordingly, the containers are received at an assembly machine that is depicted by block 110. Once each component of the fuse array has been formed and received at the assembly machine, the components are assembled into a unitary device (i.e., fuse array) as depicted by block 112. The method then ends at block 114.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of manufacturing an electrical assembly comprising:
forming a first electrical component at a first stamping machine;
forming a second electrical component at a second stamping machine;
forming a third electrical component at a third stamping machine;
receiving the first, second and third electrical components at an assembly machine; and
assembling the first, second and third electrical components into a unitary electrical assembly.

2. The method of claim 1, further comprising:
forming a fourth electrical component at a fourth stamping machine; and
receiving the fourth electrical component at the assembly machine, wherein the assembly machine assembles the first, second, third and fourth electrical components into a unitary electrical assembly.

3. The method of claim 1, wherein forming the first electrical component at the first stamping machine includes coining the first electrical component at the first stamping machine.

4. The method of claim 1, wherein assembling the first, second and third electrical components into a unitary electrical assembly includes welding the first, second and third electrical components into a unitary electrical assembly.

5. The method of claim 4, wherein welding the first, second and third electrical components includes laser welding the first, second and third electrical components.

6. The method of claim 4, wherein welding the first, second and third electrical components includes ultrasonically welding the first, second and third electrical components.

7. The method of claim 4, wherein welding the first, second and third electrical components includes resistance welding the first, second and third electrical components.

8. The method of claim 1, wherein the unitary electrical assembly includes a fuse array.

9. A system for manufacturing a fuse array comprising:
a first stamping machine forming a first electrical component;
a second stamping machine forming a second electrical component;
a third stamping machine forming a third electrical component; and
an assembly machine receiving the first, second and third electrical components, wherein the assembly machine assembles the first, second and third electrical components into a unitary electrical assembly.

10. The system of claim 9, further comprising:
a fourth stamping machine forming a fourth electrical component; and
the assembly machine the fourth electrical component, wherein the assembly machine assembles the first, second, third and fourth electrical components into a unitary electrical assembly.

11. The method of claim 9, wherein forming the first electrical component at the first stamping machine includes coining the first electrical component at the first stamping machine.

12. The method of claim 9, wherein assembling the first, second and third electrical components into a unitary electrical assembly includes welding the first, second and third electrical components into a unitary electrical assembly.

13. The method of claim 12, wherein welding the first, second and third electrical components includes laser welding the first, second and third electrical components.

14. The method of claim 12, wherein welding the first, second and third electrical components includes ultrasonically welding the first, second and third electrical components.

15. The method of claim 12, wherein welding the first, second and third electrical components includes resistance welding the first, second and third electrical components.

16. The method of claim 9, wherein the unitary electrical assembly includes a fuse array.

17. A fuse array comprising:
a bus bar having a bus bar weld interface;
a fuse element having a first fuse element weld interface and a second fuse element weld interface;
a terminal blade having a terminal blade weld interface;
wherein the bus bar is connected to the fuse element by welding the bus bar weld interface to the first fuse element weld interface; and
wherein the fuse element is connected to the terminal blade by welding the second fuse element weld interface to the terminal blade weld interface.

18. The fuse array of claim 17, wherein the fuse element has a predetermined thickness, wherein a stamping machine coins a blank to form the fuse element having the predetermined thickness.

19. The fuse array of claim 17, wherein the bus bar being connected to the fuse by welding the bus bar weld interface to the first fuse element weld interface includes laser welding or ultrasonically welding the bus bar weld interface to the first fuse element weld interface.

20. The fuse array of claim 17, wherein the fuse element being connected to the terminal blade by welding the second fuse element weld interface to the terminal blade weld interface includes laser welding or ultrasonically welding the second fuse element weld interface to the terminal blade weld interface.
